(19) United States
(12) Patent Application Publication
(10) Pub. No.: US 2008/0019376 A1
(43) Pub. Date: Jan. 24, 2008

(54) Inline network element which shares addresses of neighboring network elements

(75) Inventors: Mark A. Elias, Eastpointe, MI (US); Sherry Soja-Molloy, Taylor, MI (US)

Correspondence Address: TOLER SCHAFFER, LLP, 8500 BLUFFSTONE COVE, SUITE A201, AUSTIN, TX, 78759, US

(73) Assignee: SBC Knowledge Ventures, L.P., Reno, NV (US)

(21) Appl. No.: 11/491,547

(22) Filed: Jul. 21, 2006

(51) Int. Cl. H04L 12/56

(52) U.S. Cl. 370/395.52

(57) ABSTRACT

A first interface is connected to a first network element having a first Internet Protocol (IP) address. A second interface is connected to a second network element having a second IP address. Traffic is passed between the first interface and the second interface, and performance data is measured based on the traffic. A packet, that is addressed to the second IP address and includes a predetermined port identifier, is received by the first interface. In response to determining that the packet is addressed to the second IP address and includes the predetermined port identifier, the packet is inhibited from being passed to the second interface, and a response that includes the performance data is outputted via the first interface.

### FIELD OF THE DISCLOSURE

The present disclosure is generally related to methods and systems for addressing network elements.

### BACKGROUND

To enable devices to communicate with each other on an Internet Protocol (IP) network, each device can be assigned its own unique IP address.

Because of limitations on IP addressing and subnetting, a single point-to-point connection, also known as a two-host subnet, uses a set of four IP addresses. The four IP addresses comprise a first IP address to identify a first host device, a second IP address to identify a second host device, a third IP address to describe the subnet itself, and a fourth IP address that serves as a broadcast address for the subnet. Thus, for each subnet, two IP addresses (the third and fourth IP addresses) are not conventionally used to identify particular host devices.

Since IP subnets are based on binary numbering, subnets are sized in powers of two. Thus, a three-host IP subnet conventionally consumes eight IP addresses: six host addresses and two subnet-related addresses. Since the three hosts can be identified using a respective three host addresses instead of the six host addresses, three other host addresses are wasted.

Small IP subnets are commonly referred to as “/30” subnets based on their use of 30 bits of subnet mask. Many existing point-to-point connections use “/30” subnets.

In some circumstances, it is desired to introduce an inline network element between two hosts in an existing point-to-point connection. The inline network element can be accommodated by providing a new, larger address block. However, increasing the size of an existing IP subnet may be cumbersome and disruptive. Another option is to use a single host address for the new inline network element. However, adding new single-host IP addresses for each new inline network element increases a router table size and presents challenges in making sure that both existing endpoint devices can address the inline network element. Both of these approaches expend the number of IP Version 4 (IPv4) addresses to be administered within the network. While efforts have been made to reduce a need for more IPv4 addresses, conservation of IP addresses is important for many large service providers.

### BRIEF DESCRIPTION OF THE DRAWINGS

FIG. 1 is a schematic diagram of an embodiment of a subnet before an inline network element has been inserted;

FIG. 2 is a schematic diagram of an inline network element installed between the first and second network elements of FIG. 1 without using address sharing;

FIG. 3 is a schematic diagram of an inline network element installed between and sharing existing IP addresses of the first and second network elements of FIG. 1;

FIG. 4 is a flow chart of an embodiment of a method of using the inline network element in FIG. 3; and

FIG. 5 is a block diagram of an illustrative embodiment of a general computer system.

### DETAILED DESCRIPTION OF THE DRAWINGS

Disclosed herein are embodiments of improved methods and systems for assigning addresses to inline network elements that are inserted into a network. An inline network element inserted into an existing subnet shares an IP address already assigned to the existing subnet. Sharing the IP addresses acts to conserve IP addresses used in the network. Further, an inline network element used to gather performance or Service Level Agreement (SLA) data can be inserted into a network without modifying how the network operates and/or without relying on customer edge (CE) equipment for control and data collection connectivity. Still further, allowing an inline network element to share the IP address of a CE router mitigates a potential for isolation of the inline network element if the CE router is malfunctioning or is incorrectly configured for routing.

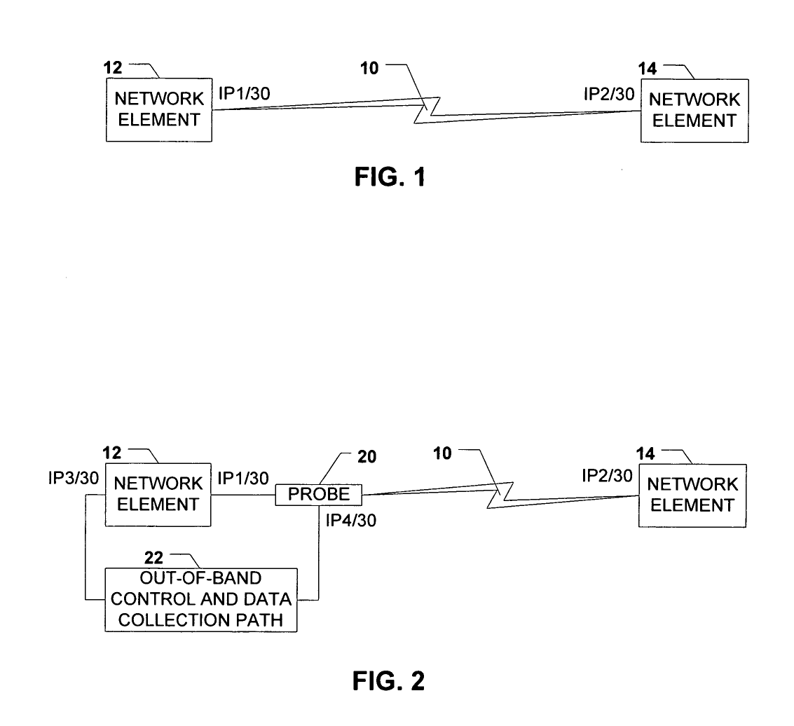

FIG. 1 is a schematic diagram of an embodiment of a subnet before an inline network element has been inserted. The subnet comprises a point-to-point connection 10 between a first network element 12, such as a first router, and a second network element 14, such as a second router. Those having ordinary skill will recognize that alternative network elements may be substituted for the first router and the second router. The first router and the second router may be any router, including but not limited to a CE router or a provider edge (PE) router.

For purposes of illustration and example, the first network element 12 is hypothetically assigned a first IP address of IP1 (e.g. 10.1.2.1), and the second network element 14 is hypothetically assigned a second IP address of IP2 (e.g. 10.1.2.2). The point-to-point connection 10 provides a “/30” IP subnet for the first network element 12 and the second network element 14.

FIG. 2 is a schematic diagram of an inline network element 20, such as a probe, installed between the first and second network elements 12 and 14 of FIG. 1 without using address sharing. The inline network element 20 undesirably introduces two more IP addresses to the network: a third IP address of IP3 (e.g. 10.1.3.6) hypothetically assigned to the inline network element 20, and a fourth IP address of IP4 (e.g. 10.1.3.5) hypothetically assigned to the first network element 12. The third IP and the fourth IP address are used by the first network element 12 and the inline network element 20 to communicate via an out-of-band control and data collection path 22. The path 22 may comprise an Ethernet connection, for example.

The out-of-band control and data collection path 22 undesirably introduces a change in configuration of the first network element 12. Further, the inline network element 20 is not directly addressable, but rather is addressable through the first network element 12. Thus, the inline network element 20 is undesirably dependent upon communications through the first network element 12 via the path 22. Such dependencies are undesirable, especially if the first network element 12 is a CE router or another substantially unmanaged network element.

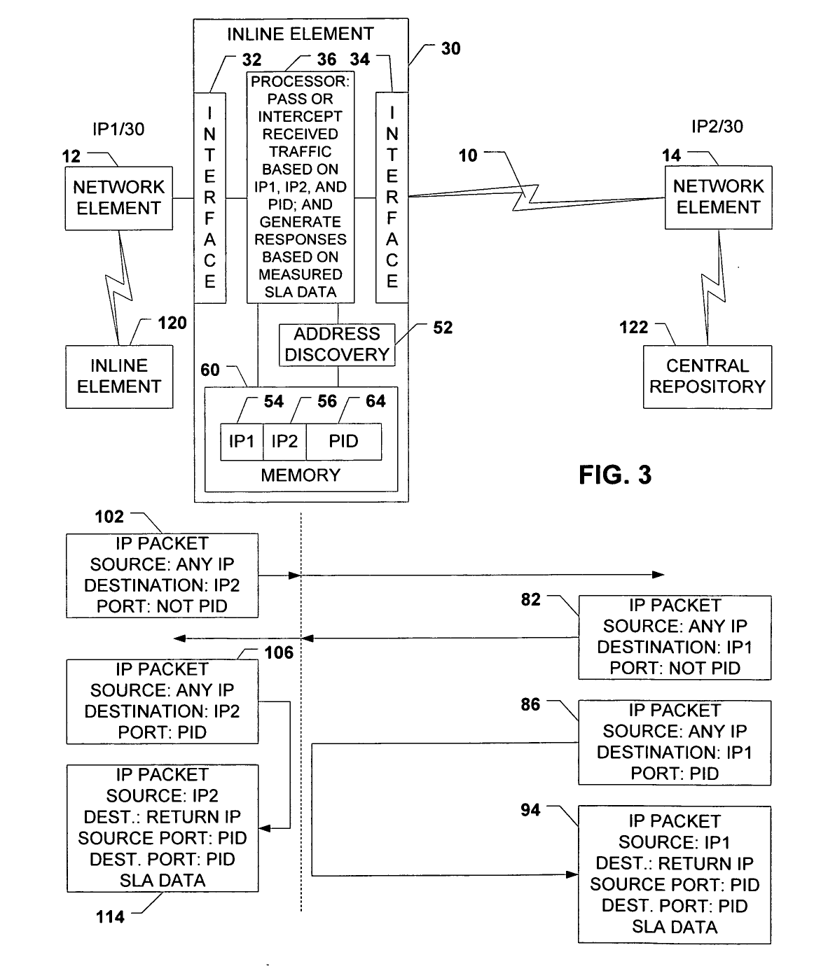

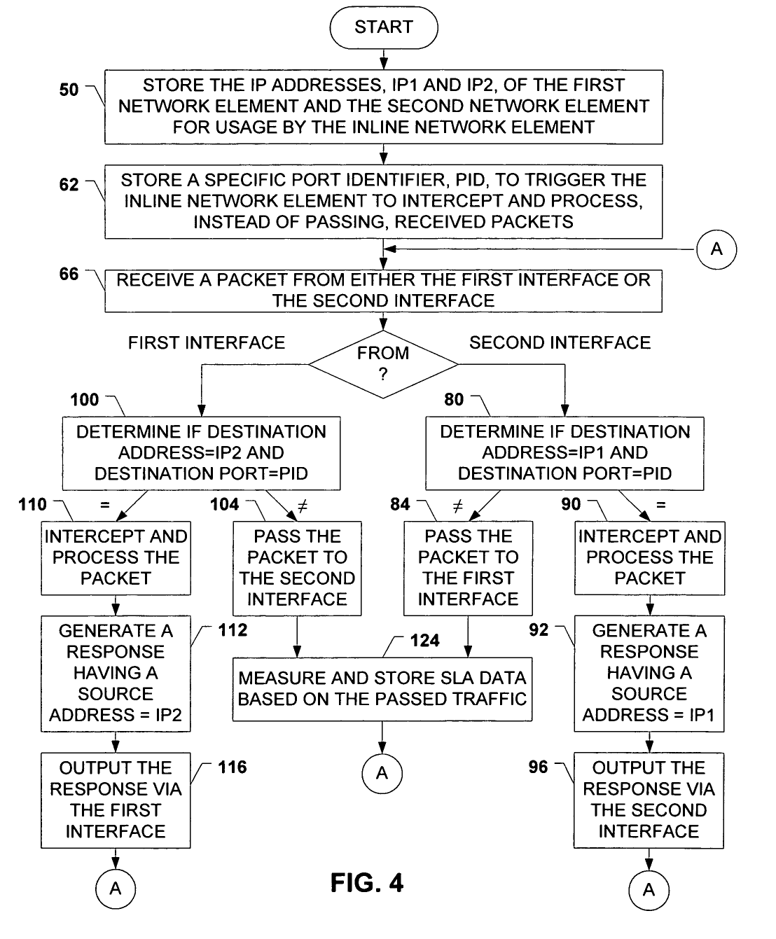

FIG. 3 is a schematic diagram of an inline network element 30 installed between and sharing existing IP addresses of the first and second network elements 12 and 14 of FIG. 1. The inline network element 30 comprises a first interface 32 connected to the first network element 12 and a second interface 34 connected to the second network element 14. Operation of the inline network element 30 is directed by a processor 36. FIG. 4 is a flow chart of an embodiment of a method of using the inline network element 30 in FIG. 3. Some or all of the acts in the method are directed by the processor 36.

As indicated by block 50, the method comprises storing the IP addresses of the first network element 12 and the second network element 14 in the inline network element 30. This act may comprise the inline network element 30 using an address discovery component 52 to automatically discover (or learn) the IP addresses of the first network element 12 and the second network element 14. The address discovery component 52 causes IP1 data 54 indicating the first IP address of the first network element 12 and IP2 data 56 indicating the second IP address of the second network element 14 to be stored in a memory 60. Alternatively, the inline network element 30 may be either manually programmed or pre-programmed to store the IP1 data 54 and the IP2 data 56 in the memory 60.

As indicated by block 62, the method comprises storing a specific port identifier (PID) 64 in the inline network element 30. The specific port identifier 64 may comprise a specific port number, for example. The specific port identifier 64 is to be used as a part of a trigger to intercept and interpret a packet instead of passing the packet along to another end of a circuit. The specific port identifier 64 may be particularly reserved for triggering traffic interception in accordance with a telecommunication standard. For example, a telecommunication standard may dictate that a Transmission Control Protocol (TCP) port and/or a User Datagram Protocol (UDP) port may be reserved specifically for triggering traffic interception as disclosed herein.

As indicated by block 66, the method comprises receiving a packet or other traffic from either the first interface 32 or the second interface 34. The traffic may comprise an IP packet having a source IP address, a destination IP address, a transport protocol, a source port number and a destination port number. The aforementioned five data elements can be contained in five fields using a combination of headers including a secondary header that is allowed by IP to define the transport layer.

If the traffic is received from the second interface 34, the method is directed to block 80 wherein the inline network element 30 determines if the destination IP address is equal to the IP1 data 54 and if the destination port number is equal to the PID 64. If at least one of above comparisons fails, which occurs if the traffic comprises a packet 82 for example, the method is directed to block 84 wherein the inline network element 30 passes the traffic to the first interface 32 for communication to the first network element 12. If both of the above comparisons are true, which occurs if the traffic comprises a packet 86 for example, the method is directed to block 90 wherein the inline network element 30 intercepts and processes the traffic instead of passing the traffic to the first interface 32.

Optionally, as indicated by block 92, the inline network element 30 generates a response 94 to the intercepted traffic. The response 94 comprises a source IP address equal to the IP1 data 54, a destination IP address equal to a return IP address, a source port number equal to the PID 64, and a destination port number equal to the PID 64. As indicated by block 96, the response 94 is outputted via the second interface 34 for communication back to the second network element 14.

If the traffic is received from the first interface 32, the method is directed to block 100 wherein the inline network element 30 determines if the destination IP address is equal to the IP2 data 56 and if the destination port number is equal to the PID 64. If at least one of above comparisons fails, which occurs if the traffic comprises a packet 102 for example, the method is directed to block 104 wherein the inline network element 30 passes the traffic to the second interface 34 for communication to the second network element 14. If both of the above comparisons are true, which occurs if the traffic comprises a packet 106 for example, the method is directed to block 110 wherein the inline network element 30 intercepts and processes the traffic instead of passing the traffic to the second interface 34.

Optionally, as indicated by block 112, the inline network element 30 generates a response 114 to the intercepted traffic. The response 114 comprises a source IP address equal to the IP2 data 56, a destination IP address equal to a return IP address, a source port number equal to the PID 64, and a destination port number equal to the PID 64. As indicated by block 116, the response 114 is outputted via the first interface 32 for communication back to the first network element 12.

By using the PID 64 as described above, the inline network element 30 is addressable from the first interface 32 using the second IP address, IP2, and addressable from the second interface 34 using the first IP address, IP1. Making the inline network element 30 reachable via at least one IP address facilitates communication of data from/to the inline network element 30 to/from other devices including but not limited to another inline network element 120 and a central repository 122. The central repository 122 may collect data from a plurality of inline network elements at different network locations.

The data communicated in the response from the inline network element 30 comprises performance or service level agreement (SLA) data for traffic passed by the inline network element 30. As indicated by block 124, the performance or SLA data is measured and captured by the inline network element 30. In general, the data may comprise usage data associated with usage of the network and performance data associated with performance of the network that are measured (or otherwise monitored) and captured (i.e. stored in a memory) by the inline network element 30. Particular examples of the performance or SLA data include, but are not limited to, gross packet counts, packet counts by class of service, and traffic volumes (e.g. by cell or packet, average and/or peak, in bits per second). The central repository 122 may be used for data collection, storage and processing of the usage data and/or the performance data from one or more inline network elements. The central repository 122 may generate an output that includes one or more values that are calculated or otherwise determined based on the data. Examples of the output include, but are not limited to, an output displayed by a display device and a hard copy output produced by a printer or another hard copy device.

For purposes of illustration and example, the inline network element 120 communicates with the inline element 30 via the first network element 12 (e.g. via a first router), and the central repository 122 communicates with the inline element 30 via the second network element 14 (e.g. via a second router). Either the central repository 122, the inline network element 120, or another network element can send a packet to the inline network element 30 to cause the inline network element 30 to output the response 114, and can receive the response 114 from the inline network element 30.

Thus, the herein-disclosed embodiments are well-suited for installing and using inline network elements for network monitoring and SLA data collection. Less time is expended for installation, and critical dependencies that could impact data collection and reporting are mitigated. The teachings herein can be applied to end-to-end SLA measurements between Multi-Protocol Label Switching (MPLS) Virtual Private Network (VPN) ports and other types of endpoints, Voice over Internet Protocol (VOIP) applications, Application Service Element (ASE) units, Channel Service Units (CSUs), Data Service Units (DSUs), and combinations thereof

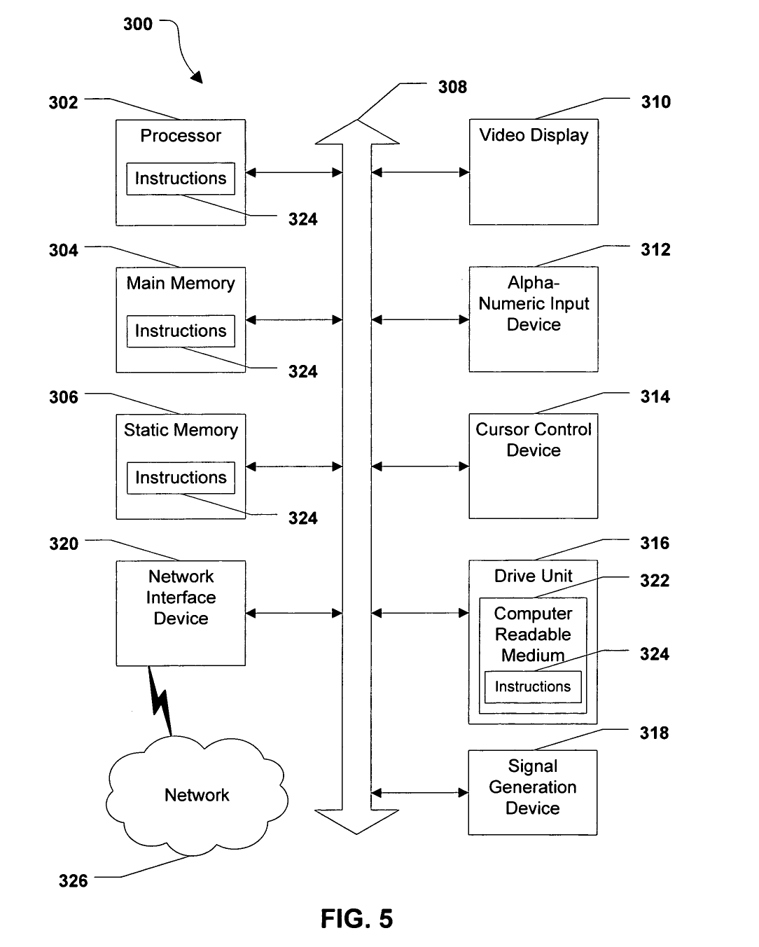

Referring to FIG. 5, an illustrative embodiment of a general computer system is shown and is designated 300. The computer system 300 can include a set of instructions that can be executed to cause the computer system 300 to perform any one or more of the methods or computer based functions disclosed herein. The computer system 300 may operate as a standalone device or may be connected, e.g., using a network, to other computer systems or peripheral devices.

In a networked deployment, the computer system may operate in the capacity of a server or as a client user computer in a server-client user network environment, or as a peer computer system in a peer-to-peer (or distributed) network environment. The computer system 300 can also be implemented as or incorporated into various devices, such as a personal computer (PC), a tablet PC, a set-top box (STB), a personal digital assistant (PDA), a mobile device, a palmtop computer, a laptop computer, a desktop computer, a communications device, a wireless telephone, a land-line telephone, a control system, a camera, a scanner, a facsimile machine, a printer, a pager, a personal trusted device, a web appliance, a network router, switch or bridge, or any other machine capable of executing a set of instructions (sequential or otherwise) that specify actions to be taken by that machine. In a particular embodiment, the computer system 300 can be implemented using electronic devices that provide voice, video or data communication. Further, while a single computer system 300 is illustrated, the term “system” shall also be taken to include any collection of systems or sub-systems that individually or jointly execute a set, or multiple sets, of instructions to perform one or more computer functions.

As illustrated in FIG. 5, the computer system 300 may include a processor 302, e.g., a central processing unit (CPU), a graphics processing unit (GPU), or both. Moreover, the computer system 300 can include a main memory 304 and a static memory 306, that can communicate with each other via a bus 308. As shown, the computer system 300 may further include a video display unit 310, such as a liquid crystal display (LCD), an organic light emitting diode (OLED), a flat panel display, a solid state display, or a cathode ray tube (CRT). Additionally, the computer system 300 may include an input device 312, such as a keyboard, and a cursor control device 314, such as a mouse. The computer system 300 can also include a disk drive unit 316, a signal generation device 318, such as a speaker or remote control, and a network interface device 320.

In a particular embodiment, as depicted in FIG. 5, the disk drive unit 316 may include a computer-readable medium 322 in which one or more sets of instructions 324, e.g. software, can be embedded. Further, the instructions 324 may embody one or more of the methods or logic as described herein. In a particular embodiment, the instructions 324 may reside completely, or at least partially, within the main memory 304, the static memory 306, and/or within the processor 302 during execution by the computer system 300. The main memory 304 and the processor 302 also may include computer-readable media.

In an alternative embodiment, dedicated hardware implementations, such as application specific integrated circuits, programmable logic arrays and other hardware devices, can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

The present disclosure contemplates a computer-readable medium that includes instructions 324 or receives and executes instructions 324 responsive to a propagated signal, so that a device connected to a network 326 can communicate voice, video or data over the network 326. Further, the instructions 324 may be transmitted or received over the network 326 via the network interface device 320.

While the computer-readable medium is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to capture carrier wave signals such as a signal communicated over a transmission medium. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

Although the present specification describes components and functions that may be implemented in particular embodiments with reference to particular standards and protocols, the invention is not limited to such standards and protocols. For example, standards for Internet and other packet switched network transmission (e.g., TCP/IP, UDP/IP, HTML, HTTP) represent examples of the state of the art. Such standards are periodically superseded by faster or more efficient equivalents having essentially the same functions. Accordingly, replacement standards and protocols having the same or similar functions as those disclosed herein are considered equivalents thereof.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An apparatus comprising:
a first interface to connect to a first network element having a first Internet Protocol (IP) address;
a second interface to connect to a second network element having a second IP address; and
a processor to cause traffic to be passed between the first interface and the second interface, the processor to measure performance data based on the traffic, the processor to cause the first interface to output the performance data in response to the first interface receiving a first packet addressed to the second IP address and including a predetermined port identifier, the processor to cause the second interface to output the performance data in response to the second interface receiving a second packet addressed to the first IP address and including the predetermined port identifier.

2. The apparatus of claim 1 further comprising:
an address discovery component to discover the first IP address of the first network element and the second IP address of the second network element for use by the processor to cause the performance data to be outputted.

3. The apparatus of claim 1 wherein the processor is to inhibit the first packet from being passed to the second interface, and to inhibit the second packet from being passed to the first interface.

4. The apparatus of claim 1 wherein the processor is to inhibit all traffic that is received by the first interface, is addressed to the second IP address and includes the predetermined port identifier, from being passed to the second interface.

5. The apparatus of claim 4 wherein the processor is to inhibit all traffic that is received by the second interface, is addressed to the first IP address and includes the predetermined port identifier, from being passed to the first interface.

6. The apparatus of claim 1 wherein the performance data is outputted in at least one packet whose destination port identifier includes the predetermined port identifier.

7. The apparatus of claim 1 wherein the first network element comprises a first router and wherein the second network element comprises a second router.

8. The apparatus of claim 1 wherein the performance data comprises service level agreement (SLA) data.

9. A method comprising:
providing a first interface to connect to a first network element having a first Internet Protocol (IP) address;
providing a second interface to connect to a second network element having a second IP address; and
passing traffic between the first interface and the second interface;
measuring performance data based on the traffic;
receiving a first packet by the first interface;
determining that the first packet is addressed to the second IP address and includes a predetermined port identifier; and
in response to said determining, inhibiting the first packet from being passed to the second interface and outputting a first response via the first interface, the first response including the performance data.

10. The method of claim 9 further comprising:
automatically discovering the first IP address of the first network element and the second IP address of the second network element.

11. The method of claim 9 further comprising:
inhibiting all traffic, including the first packet, that is received by the first interface, is addressed to the second IP address and includes the predetermined port identifier, from being passed to the second interface.

12. The method of claim 11 further comprising:
inhibiting all traffic that is received by the second interface, is addressed to the first IP address and includes the predetermined port identifier, from being passed to the first interface.

13. The method of claim 9 wherein the first response includes at least one packet whose destination port identifier includes the predetermined port identifier.

14. The method of claim 9 further comprising:
receiving a second packet by the second interface;
determining that the second packet is addressed to the first IP address and includes the predetermined port identifier; and
in response to said determining that the second packet is addressed to the first IP address and includes the predetermined port identifier, inhibiting the second packet from being passed to the first interface and outputting a second response via the second interface, the second response including the performance data.

15. The method of claim 9 wherein the first network element comprises a first router, and wherein the second network element comprises a second router.

16. The method of claim 9 wherein the performance data comprises service level agreement (SLA) data.

17. A computer-readable medium having computer-readable program code to cause a network element having a first interface and a second interface to perform acts of:
passing traffic between the first interface and the second interface, the first interface being connected to a first network element having a first Internet Protocol (IP) address, the second interface being connected to a second network element having a second IP address;
measuring performance data based on the traffic;
receiving a first packet by the first interface;
determining that the first packet is addressed to the second IP address and includes a predetermined port identifier; and
in response to said determining, inhibiting the first packet from being passed to the second interface and outputting a first response via the first interface, the first response including the performance data.

18. The computer-readable medium of claim 17 wherein the acts further comprise:
automatically discovering the first IP address of the first network element and the second IP address of the second network element.

19. The computer-readable medium of claim 17 wherein the acts further comprise:
inhibiting all traffic, including the first packet, that is received by the first interface, is addressed to the second IP address and includes the predetermined port identifier, from being passed to the second interface.

20. The computer-readable medium of claim 19 wherein the acts further comprise:
inhibiting all traffic that is received by the second interface, is addressed to the first IP address and includes the predetermined port identifier, from being passed to the first interface.

21. The computer-readable medium of claim 17 wherein the first response includes at least one packet whose destination port identifier includes the predetermined port identifier.

22. The computer-readable medium of claim 17 wherein the acts further comprise:
receiving a second packet by the second interface;
determining that the second packet is addressed to the first IP address and includes the predetermined port identifier; and
in response to said determining that the second packet is addressed to the first IP address and includes the predetermined port identifier, inhibiting the second packet from being passed to the first interface and outputting a second response via the second interface, the second response including the performance data.

23. The computer-readable medium of claim 17 wherein the performance data comprises service level agreement (SLA) data.

24. A method comprising:
sending a packet to an inline network element having a first interface and a second interface, the first interface connected to a first network element having a first Internet Protocol (IP) address, the second interface connected to a second network element having a second IP address, the packet being sent via the first network element to the first interface, the packet being addressed to the second IP address and including a predetermined port identifier; and
receiving a response to the packet from the inline network element, the response being outputted via the first interface, the response including performance data measured by the inline network element based on traffic passed between the first interface and the second interface.

25. The method of claim 24 wherein the performance data comprises service level agreement (SLA) data.
